(19) United States
(12) Patent Application Publication
(10) Pub. No.: US 2025/0276805 A1
(43) Pub. Date: Sep. 4, 2025

(54) SYSTEM FOR REMOVABLY FASTENING A SCREEN TO AN INSTRUMENT PANEL OF AN AIRCRAFT, AND VISUALIZATION SYSTEM COMPRISING SUCH A FASTENING SYSTEM

(71) Applicant: Airbus Operations SAS, TOULOUSE (FR)

(72) Inventors: Franck CROSTA, TOULOUSE (FR); Olivier FOURCADE, TOULOUSE (FR); Yannick KAUFLING, TOULOUSE (FR); Nicolas WILLOT, TOULOUSE (FR); Lionel JAMET, TOULOUSE (FR)

(21) Appl. No.: 19/063,877

(22) Filed: Feb. 26, 2025

(30) Foreign Application Priority Data
Feb. 29, 2024 (FR) 2402009

(51) Int. Cl. B64D 43/00

(52) U.S. Cl. CPC B64D 43/00

(57) ABSTRACT

A fastening system comprises a rail, a fastening device to fasten the rail to an instrument panel of a cockpit of an aircraft without modification of the instrument panel, and at least one movable carriage provided with a support device and configured to move in translation along the rail and to be brought into an operation position, the support device being provided with a support bracket to bear the screen and to be raised into the operation position and lowered on the movable carriage during a translational movement of the movable carriage on the rail.

### CROSS-REFERENCES TO RELATED APPLICATIONS

This application claims the benefit of French Patent Application Number 2402009 filed on Feb. 29, 2024, the entire disclosure of which is incorporated herein by way of reference.

### FIELD OF THE INVENTION

The present invention relates to a system for removably fastening a screen to an instrument panel of a cockpit of an aircraft, and to a visualization system comprising a screen and such a fastening system.

### BACKGROUND OF THE INVENTION

It is known that it may be useful or necessary to install an additional screen on the instrument panel of an aircraft, in particular of a transport plane.

More particularly, although not exclusively, it may be a screen intended to help with carrying out tests during test flights of the aircraft. Such a test screen may, for example, be used in an on-board simulation system, such as described in patent application FR2005575. This test screen is disposed in front of a customary screen of the aircraft during a given phase of the test flight and can be retracted when it is no longer being used in order to free up the customary screen.

Since the use of an additional screen is in principle temporary, there is a need to find a solution which makes it possible to install an additional screen on the instrument panel of a cockpit of an aircraft, with simple and rapid installation and also simple and rapid deinstallation, without having to modify the equipment of the instrument panel.

### SUMMARY OF THE INVENTION

It is an object of the present invention to propose a solution for meeting the aforementioned need. The present invention relates to a system for removably fastening at least one screen to an instrument panel of a cockpit of an aircraft.

According to the invention, said fastening system comprises:
a rectilinear rail having a longitudinal axis;
a fastening device intended to fasten the rail to the instrument panel without modification of said instrument panel; and
at least one movable carriage provided with a support device, said movable carriage being configured to be able to be moved in translation along said rail and to be brought at least into what is referred to as an operation position, said support device being provided with a support bracket intended to bear the screen, the support bracket being able to pivot about an axis parallel to said longitudinal axis and being configured to, by the pivoting thereof, be able to be raised into what is referred to as a raised configuration, at least in said operation position, and to be able to be lowered on the movable carriage into what is referred to as a lowered configuration, at least during a translational movement of said movable carriage on the rail.

Thus, by virtue of the invention, the fastening system and also an additional screen borne by this fastening system can be easily and rapidly installed on the instrument panel of a cockpit of an aircraft (and also be easily and rapidly deinstalled), without modification of the instrument panel and equipment in the cockpit.

Said fastening system also has other advantages specified below.

In a preferred embodiment, the movable carriage is configured to be able to be brought, by translational movement on the rail, into an end position on said rail, and the support device is able to pivot with respect to a panel of the movable carriage, about an axis which is transverse to said longitudinal axis, and it is configured to, by the pivoting thereof, be able, at least in said end position of the movable carriage, to be raised into what is referred to as a rest configuration.

Advantageously, said support device additionally comprises an auxiliary bracket, and the support bracket is able to pivot with respect to said auxiliary bracket by way of a hinge arranged at a first side, and it is configured to be able to be brought, by pivoting, into one or the other of the two following configurations:
the lowered configuration, in which the support bracket is folded down on the auxiliary bracket so as to create between them a receptacle intended to receive the screen and the support bracket and the auxiliary bracket are secured to one another at a second side on the opposite side from said first side; and
a raised configuration, in which the support bracket is raised with respect to the auxiliary bracket such that the support bracket and the auxiliary bracket are positioned substantially orthogonally with respect to one another.

In addition, advantageously, a first face of the auxiliary bracket and a first face of a plate connected to a panel of the movable carriage are in contact with one another and are connected to one another by way of, for the one part, a plurality of pins which are secured to at least one of said first faces and enter complementary and cooperating holes provided in the other of said first faces, and, for the other part, at least one double-sided adhesive strip, each face of which is adhesively bonded to one of said first faces of the auxiliary bracket and of the plate.

Furthermore, in a particular embodiment, the fastening system comprises a locking element configured to be able to lock the movable carriage in position on the rail.

Furthermore, advantageously, the fastening device comprises two fastening components arranged below the rail, each of said fastening components comprises a lower face intended to be fastened to one of the two footrests intended for a pilot of the aircraft and an upper face to which the rail is fastened, and is configured such that, when the fastening system is mounted on the instrument panel, the rail is positioned substantially horizontally.

Furthermore, in a particular embodiment, the fastening system comprises at least one bearing component arranged below the rail.

Advantageously, the fastening system also comprises a pivoting arm able to pivot about an axis transverse to said axis so as to be able to be brought into one or the other of the two following positions:
a retracted position, in which it is retracted in a panel of the movable carriage; and
an inclined position, in which a free end of the pivoting arm enters an opening in a plate of the support device in order to hold the support device in a rest configuration.

Furthermore, in a particular embodiment, the fastening system also comprises self-gripping attachment means for attaching together different elements of the fastening system.

The present invention also relates to a visualization system for an instrument panel of a cockpit of an aircraft, said visualization system comprising at least one screen.

According to the invention, said visualization system additionally comprises a system for removable fastening as described above, to which the screen is fastened and which is intended to be fastened to the instrument panel of the cockpit of the aircraft.

### BRIEF DESCRIPTION OF THE DRAWINGS

The appended figures will make it easy to understand how the invention may be implemented. In these figures, identical reference signs denote similar elements.

FIG. 1 is a partial perspective view of an internal part of a cockpit of an aircraft, provided with a visualization system according to one embodiment of the invention, comprising a support device in a raised configuration, in an operation position.

FIG. 2 is a view similar to that of FIG. 1, with the support device in a lowered configuration.

FIG. 3 is a side view of the visualization system with the support device in the raised configuration as in FIG. 1.

FIG. 4 is a side view of the visualization system with the support device in the lowered configuration as in FIG. 2.

FIG. 5 is a partial perspective view of an internal part of the cockpit of the aircraft, provided with the visualization system, with the support device, in a rest configuration, in an end position.

FIG. 6 is an exploded perspective view, as seen from below, of part of a rail, provided with a support device bearing a screen.

FIG. 7 is a view similar to that of FIG. 6, as seen from slightly above.

FIG. 8 is a perspective view of a rail provided with a movable carriage and with a plate.

FIG. 9 is a transverse view of part of a rail, provided with a panel and with a locking element.

FIG. 10 is a perspective view of part of a rail, fastened to a footrest.

FIG. 11 is a slightly perspective view of a hinge of the support device, connecting a support bracket to an auxiliary bracket.

### DETAILED DESCRIPTION OF THE PREFERRED EMBODIMENTS

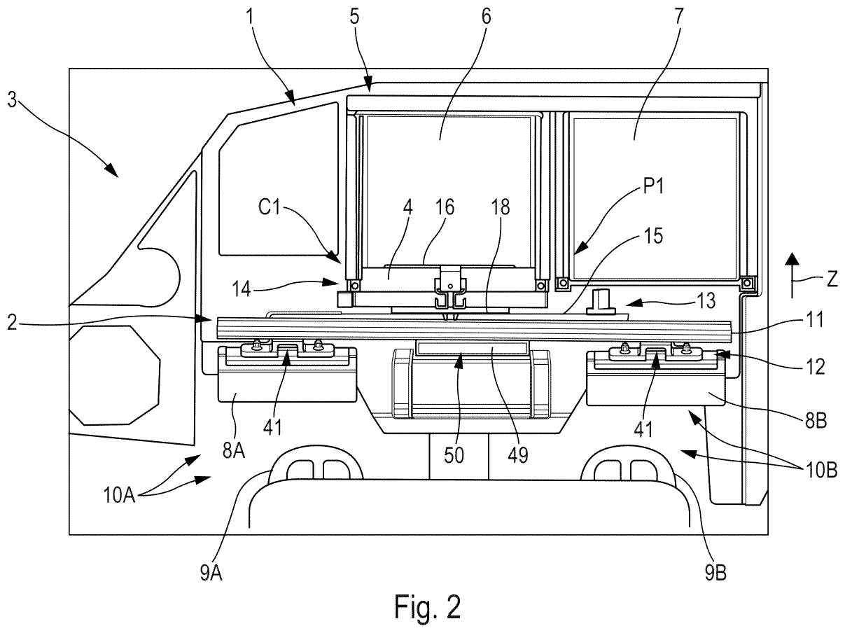

The system 1 illustrating the invention and shown schematically, in a particular embodiment, in FIGS. 2 to 5 is intended to be mounted on an instrument panel 2 of a cockpit 3 of an aircraft, in particular of a transport plane.

More specifically, the system 1 is intended to fasten at least one screen 4 to the instrument panel 2. The system 1 and the screen 4 form part of a visualization system 5. The screen 4 can be any type of additional screen that a pilot of the aircraft may need, and notably a screen intended to be used when carrying out tests.

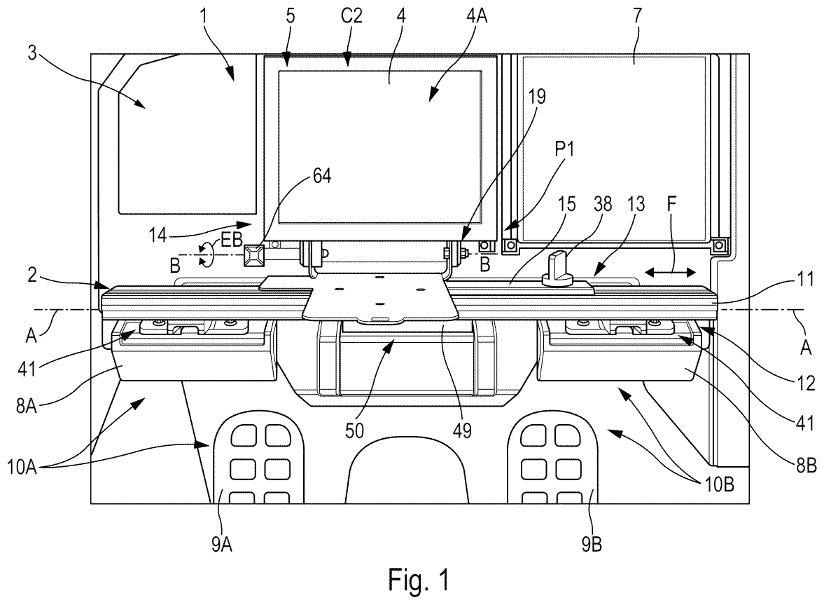

FIGS. 1 and 2 show part of the cockpit 3, in the region of the seat of a pilot. The shown part of the cockpit 3 notably comprises the instrument panel 2, two customary screens 6 and 7 (of which only the screen 7 is visible in FIG. 1) and two footrest systems 10A and 10B. Each footrest system 10A, 10B comprises a footrest 9A, 9B, and a support 8A, 8B for supporting the footrest 9A, 9B, which is fastened in the cockpit 3.

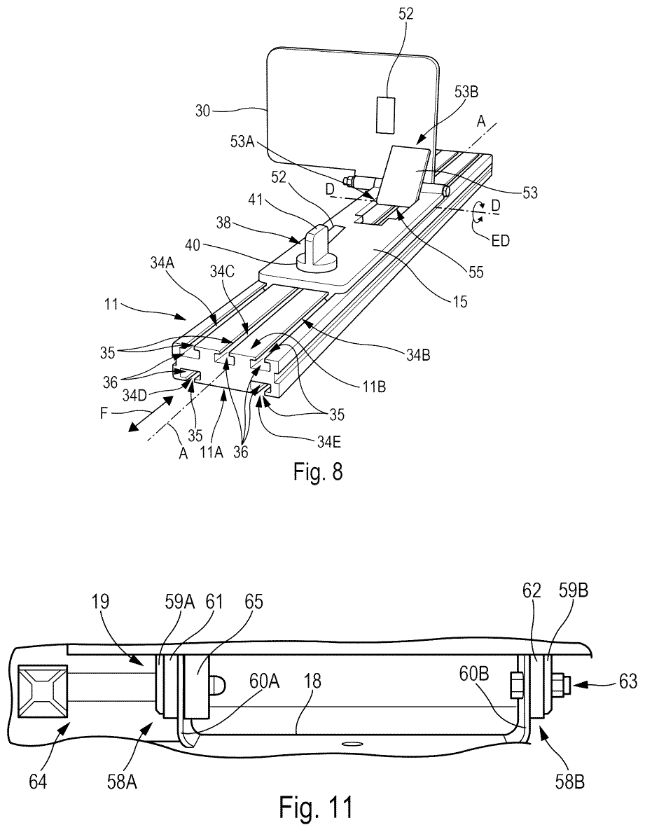

The system 1, which can be arranged in the region of the seat of one or the other of the two pilots of the aircraft, comprises, as shown in FIG. 1:
a rectilinear rail 11 having a longitudinal axis A-A (FIGS. 1 and 8);
a fastening device 12 intended to (removably) fasten the rail 11 to the instrument panel 2, without modification of said instrument panel 2, as specified below; and
at least one movable carriage 13 provided with a support device 14 intended to receive the screen 4.

The description below relates to a system 1 provided with a single movable carriage 13 (comprising a support device 14 bearing a screen 4). However, it is also conceivable, in the context of the present invention, for the system 1 to comprise a plurality of movable carriages (and notably two movable carriages) mounted on the same rail, each of the movable carriages comprising a support device bearing a screen.

In the context of the present invention:
the adjectives “upper” and “lower” are defined with respect to a vertical direction, illustrated by an arrow Z in FIG. 2, in the cockpit 3 when the system 1 is mounted on the aircraft, the adjective “upper” being defined in the direction of the arrow Z and the adjective “lower” being defined in the direction opposite to that of the arrow Z; and
the adjective “horizontal” corresponds to a surface which is positioned substantially (+/−10%) horizontally when the aircraft is on the ground, namely which is orthogonal to the direction illustrated by the arrow Z.

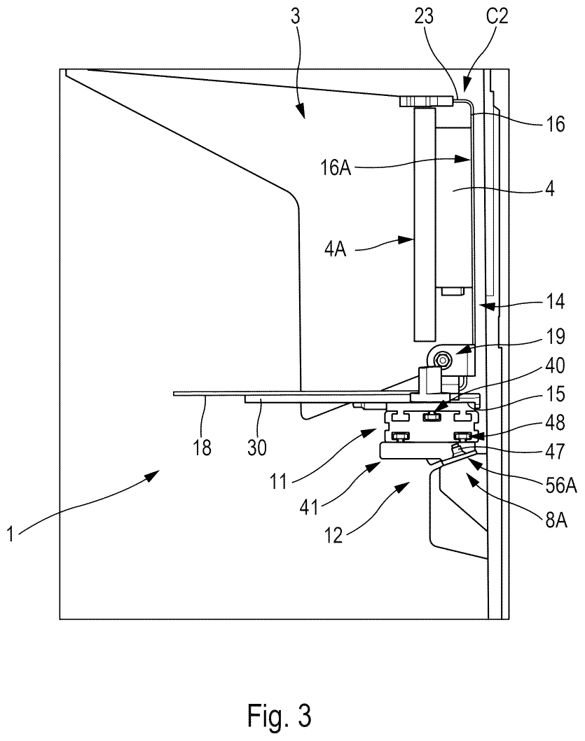

The movable carriage 13 comprises a panel 15 corresponding to a longitudinal rectangular plate, which is able to slide on the rail 11, and to which the support device 14 is connected, as shown notably in FIGS. 3, 4 and 6.

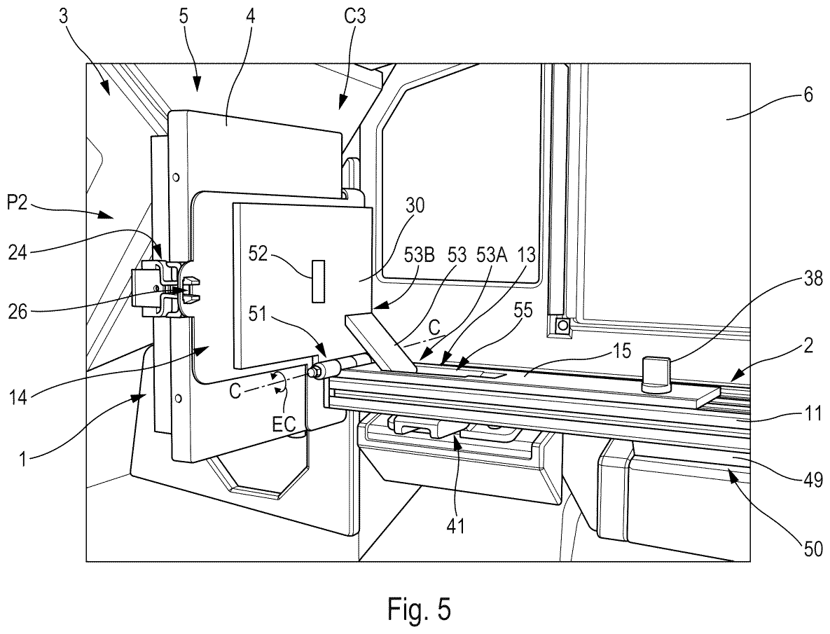

The movable carriage 13 is configured to be able to be moved in translation along the rail 11 (in a direction parallel to the longitudinal axis A-A), as illustrated by a double-headed arrow F in FIGS. 1 and 8, and it can be brought along said rail 11, notably:
into what is referred to as an operation position P1, as shown in FIGS. 1 and 2; and
into an end position P2, as shown in FIG. 5.

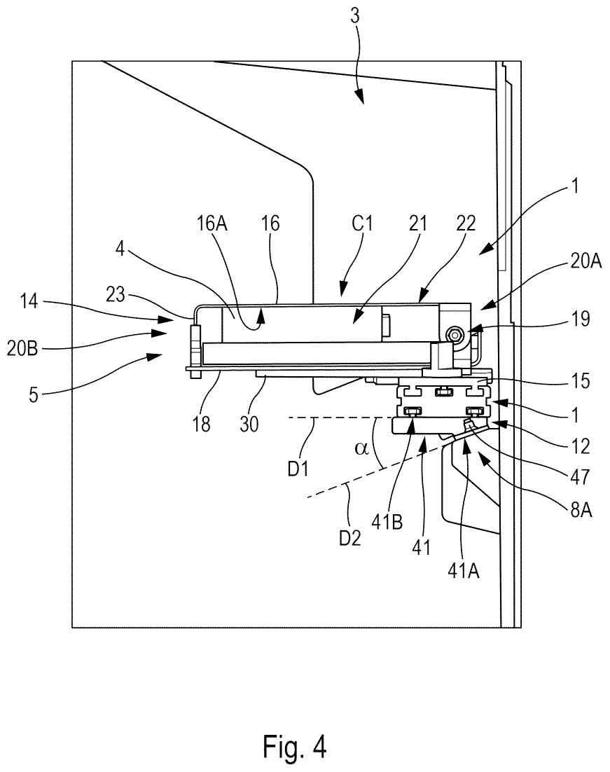

The support device 14 comprises a support bracket 16 (FIGS. 3, 4 and 7) corresponding to a planar plate, which is intended to bear the screen 4. To this end, the screen 4 is fastened in a customary manner to a face 16A (FIGS. 3 and 4) of the support bracket 16. Preferably, the screen 4 is fastened by screws 17, the heads of which are shown schematically in FIG. 7.

In a preferred embodiment, the support bracket 16 (for example the position of holes for the passage of screws 17) is adapted to fasteners provided on the screen 4 which is used. This makes it possible to easily adapt the system 1 to screens having different positions for the fastening points.

The support device 14 additionally comprises an auxiliary bracket 18 corresponding to a planar plate, as shown in FIGS. 3 and 4.

The support bracket 16 is able to pivot with respect to the auxiliary bracket 18 by way of a customary hinge 19, arranged at a side 20A (FIG. 4). The support bracket 16 is able to pivot, about an axis B-B, as illustrated by a double-headed arrow EB in FIGS. 1 and 7. This axis B-B is parallel to said longitudinal axis A-A.

The support bracket 16 is configured to be able to be brought, by pivoting, into one or the other of the two following configurations: a lowered configuration and a raised configuration (or presentation configuration).

In the lowered configuration C1, shown in FIG. 4 in particular, the support bracket 16 is folded down on the auxiliary bracket 18 so as to create between them a receptacle 21 intended to receive the screen 4.

In the lowered configuration C1, the support bracket 16 is connected to the auxiliary bracket at a side 20B on the opposite side from said side 20A such that they form a (partially open) support shell 22.

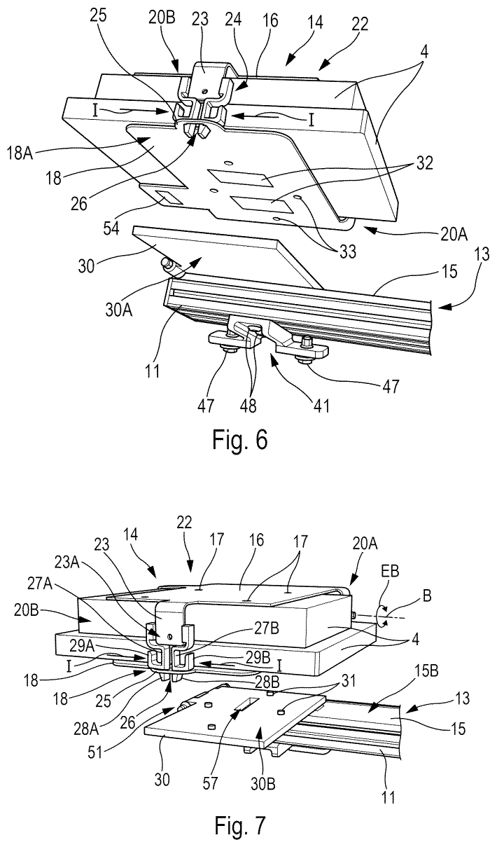

As shown in FIGS. 6 and 7, the support bracket 16 is provided, on the side 20B, with a planar plate 23 connected by a bend to the support bracket 16. A clamp 24 is fastened to the free end 23A of this plate 23.

The auxiliary bracket 18 is provided, on the side 20B (on the opposite side from the side 20A), with a projecting tab 25 provided with an opening 26. The clamp 24 is configured to be able to be hooked in the opening 26, as shown in FIG. 7. To this end, the clamp 24 comprises two flexible arms 27A and 27B each provided, at the free end thereof, with a hook 28A and 28B. In the lowered configuration C1, the clamp 24 enters the opening 26 and is hooked, by way of its hooks 28A and 28B, at the edges of this opening 26.

An (L-shaped) angle bracket 29A, 29B is connected to each flexible arm 27A, 27B. Pressure on the angle brackets 29A and 29B, in the direction illustrated by arrows I in FIGS. 6 and 7, moves the arms 27A and 27B towards one another and releases the hooks 28A and 28B which can then be removed from the opening 26. This makes it possible to raise the support bracket 16 (which pivots about the hinge 19) and to disconnect the two brackets 16 and 18 on the side 20B.

In the raised configuration C2, shown in FIG. 3, the support bracket 16 is raised with respect to the auxiliary bracket 18 such that the support bracket 16 and the auxiliary bracket 18 are positioned substantially orthogonally with respect to one another.

Since the auxiliary bracket 18 remains arranged in a horizontal position on the rail 11 (as specified below), the support bracket 16 is thus brought into a vertical position. In this vertical position, a face 4A of the screen 4 (fastened to the face 16A of the support bracket 16) is visible, as shown in FIGS. 1 and 3. The face 4A is the face for displaying or presenting information of the screen 4. In this raised configuration C2, the screen 4 can therefore be used by the pilot.

In order to pass from the lowered configuration C1 to the raised configuration C2, the support bracket 16 is therefore pivoted with respect to the auxiliary bracket 18 by way of the pivot hinge 19, provided with two articulations 58A and 58B. As shown in FIG. 11, the hinge 19 comprises tabs 59A and 59B which are connected to the support bracket 16 and cooperate, respectively, with tabs 60A and 60B connected to the auxiliary bracket 18. At the articulation 58A, a washer 61 is arranged between the tabs 59A and 60A, and at the articulation 58B, a washer 62 is arranged between the tabs 59B and 60B. A connecting component 63 which passes through the holes in the tabs 59B and 60B and in the washer 62 connects together these components. At the articulation 58A, the tabs 59A and 60A and the washer 61 are connected together by way of a screw adjuster 64 provided with a nut 65.

The screw adjuster 64, by being screwed, generates a stress on the articulation 58A in order to lock its movement and thus prevent the pivoting of the support bracket 16 with respect to the auxiliary bracket 18. The screw adjuster 64 is configured to prevent that the auxiliary bracket 18 pivots with respect to the support bracket 16 in the raised configuration C2 and remains in its vertical position.

In a particular embodiment, the washers 61 and 62 comprise thrust balls for generating a position-maintaining force in a predefined relative position between the two brackets 16 and 18, in the present case when they are positioned substantially orthogonally with respect to one another in the raised configuration C2.

Furthermore, the support device 14 additionally comprises a plate 30, as shown in FIGS. 6 and 7 in particular.

The plate 30 is connected by a lower face 30A (FIG. 6) to an upper face 15B (FIG. 7) of the panel 15, as specified below.

In addition, the auxiliary bracket 18 of the support shell 22 is connected to said plate 30. More specifically, the lower face 18A (FIG. 6) of the auxiliary bracket 18 and an upper face 30B (FIG. 7) of the plate 30 are in contact with one another. These faces 18A and 30B are connected to one another by way of a plurality of pins 31 (FIG. 7) and at least one double-sided adhesive strip 32 (FIG. 6), that is to say a strip whose two faces are adhesive.

One of the adhesive faces of the double-sided adhesive strip 32 is thus adhesively bonded to the lower face 18A of the auxiliary bracket 18 and the other adhesive face of the double-sided adhesive strip 32 is adhesively bonded to the upper face 30B of the plate 30. In the example of FIG. 6, two adhesive strips 32, of rectangular shape, are provided on the face 18A of the auxiliary bracket 18.

Furthermore, as shown in FIG. 7, the pins 31 are fastened to the upper face 30B of the plate 30 and, in the assembled position of the auxiliary bracket 18 and of the plate 30, the pins 31 enter complementary and cooperating holes 33 (FIG. 6) provided in the lower face 18A of the auxiliary bracket 18. Of course, it is also conceivable to provide the pins on the face 30B and cooperating holes on the face 18A, or to provide pins on the two faces 18A and 30B, which are associated with holes provided in each case on the opposite face.

The means for attaching the support shell 22 (provided with the screen 4) to the plate 30 connected to the rail 11, which comprise the pins 31 and the adhesive strips 32, make it possible:
for the one part, to provide an attachment sufficient for the different operations to be carried out; and
for the other part, to detach or tear off the support shell 22 (and the screen 4) from the system 1, by manually pulling the support shell 22 in the direction of the arrow Z in the lowered configuration (FIG. 2).

This makes it possible, notably in the event of an emergency, for the pilot to very rapidly remove the screen 4 (surrounded by the support shell 22) from the instrument panel 2.

In a preferred embodiment, notably the auxiliary bracket 18 and the plate 30 are produced by an additive manufacturing process, making it possible to reduce the manufacturing cost of these components and thus of the system 1. In addition, these components can, in this case, be produced easily.

As indicated above, the movable carriage 13 is configured to be able to be moved in translation along the rail 11, as illustrated by a double-headed arrow F in FIGS. 1 and 8, and it can be brought along said rail 11, notably:
into the operation position P1 shown in FIGS. 1 and 2; and
into the end position P2 shown in FIG. 5.

The movable carriage 13 can thus be brought into the desired position by the pilot, in order for the screen 4 to be disposed exactly at the location desired by the pilot in the raised configuration, i.e., preferably within their field of vision when they are seated on their seat in order to prevent them having to turn their head when they wish to view the screen 4.

To this end, in a particular embodiment, the rail 11, which is for example produced from metal and notably from aluminum, comprises, as shown in FIG. 8, three rectilinear guides 34A, 34B and 34C which are parallel to the longitudinal axis A-A, namely a central guide 34C and two guides 34A and 34B arranged on either side of this central guide 34C.

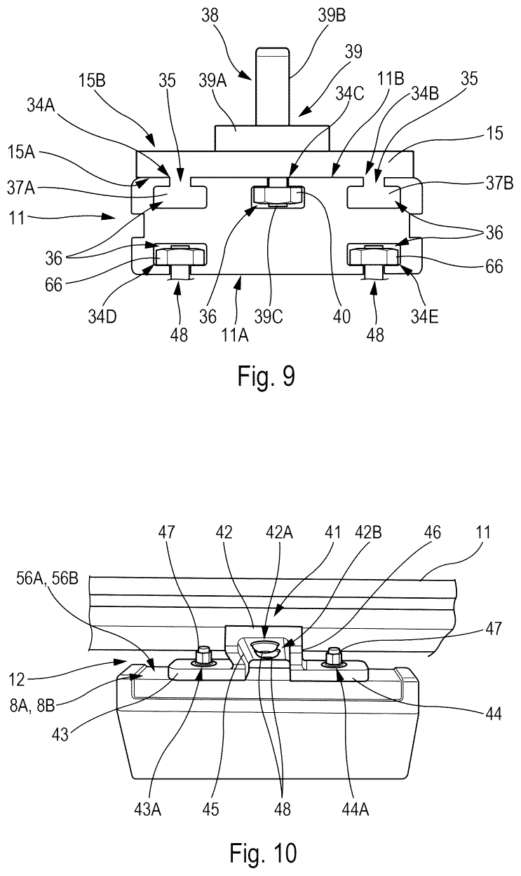

The three guides 34A, 34B and 34C (FIG. 9) have a similar shape in cross section, comprising on the upper face 11B of the rail 11 a longitudinal slot 35, leading into a longitudinal groove 36 of substantially rectangular general shape.

The panel 15, for its part, is provided on its lower face 15A with two longitudinal ribs 37A and 37B. These longitudinal ribs 37A and 37B have a rectangular general shape in cross section, which is complementary to that of the grooves 36, and they are inserted in the grooves 36 of the two guides 34A and 34B.

This cooperation of shape between the ribs 37A and 37B and the grooves 36 allows the panel 15 to be held on the rail 11 and to be able to be moved longitudinally on the rail 11.

Furthermore, in a particular embodiment, the system 1 also comprises a locking element 38 (FIG. 9) for locking the panel 15 and therefore the movable carriage 13 in position on the rail 11, that is to say for preventing the movement of the movable carriage 13 when it is locked.

The locking element 38 comprises a screw 39 provided with a head 39A (comprising a gripping plate 39B) and with a threaded stem 39C, as shown in FIG. 9.

The head 39A of the locking element 38 rests on the upper face 15B of the panel 15 and the threaded stem 39C passes through the slot 35 of the guide 34C and ends in the groove 36 of the guide 34C. A nut 40 is housed in this groove 36 and is screwed on the threaded stem 39C.

Thus:
in order to lock the movable carriage 13 in position on the rail 11, it suffices for the locking element 38 to be screwed (by manually turning the gripping plate 39B) until clamping between the nut 40 and the head 39A is obtained that is sufficient to hold the panel 15 against the rail 11; and
in order to unlock the movable carriage 13 so as to allow it to move in translation along the rail 11, it suffices to loosen the locking element 38 enough to allow the panel 15 to be able to be moved with respect to the rail 11.

Furthermore, the rail 11 also comprises, as shown in FIGS. 8 and 9, two rectilinear guides 34D and 34E which are parallel to the longitudinal axis A-A and are intended for the fastening of the rail 11 as specified below.

In the embodiment shown, the guides 34D and 34E have a similar shape in cross section to that of the guides 34A, 34B and 34C, comprising on the lower face 11A of the rail 11 a longitudinal slot 35, leading into a groove 36 of substantially rectangular general shape.

Furthermore, the fastening device 12 comprises two fastening components 41 arranged below the rail 11, in the region respectively of the supports 8A and 8B of the footrests 9A and 9B.

The function of these fastening components 41 is to fasten the system 1 (bearing the screen 4) to the aircraft. One of the fastening components 41 is intended to be fastened to the support 8A of the footrest 9A and the other fastening component 41 is intended to be fastened to the support 8B of the footrest 9B.

As shown in FIG. 10, each fastening component 41 comprises a central plate 42 and two lateral plates 43 and 44 arranged on either side of the central plate 42 and connected to the latter, respectively, by tabs 45 and 46.

Each of the lateral plates 43 and 44 is provided with a hole 43A, 44A and is able to be fastened by way of a bolt 47 to the support 8A, 8B of a footrest 9A, 9B.

Customarily, each support 8A, 8B of a footrest 9A, 9B comprises two pre-existing holes, which are intended to receive a cover which is removed before fastening the fastening component 41. The holes 43A and 44A in the lateral plates 43 and 44 of the fastening component 41 are formed and positioned so as to be able to be superposed with the pre-existing holes in the supports 8A and 8B.

Thus, the rail 11 and therefore the system 1 can be fastened to the aircraft without needing to modify the instrument panel 2 or equipment in the cockpit of the aircraft, by using holes that already exist in the supports 8A and 8B of the footrests 9A and 9B.

In addition, two holes 42A and 42B are provided in the central plate 42 in order to allow it to be fastened below the rail 11 with the aid of two fastening elements 48, preferably bolts, which pass through these holes 42A and 42B and comprise nuts 66 arranged respectively in the grooves 36 of the guides 34D and 34E, as shown in FIG. 9.

The upper face 56A, 56B of each support 8A, 8B of a footrest 9A, 9B does not have a horizontal surface. Thus, the fastening components 41 arranged on these upper faces 56A and 56B are formed so as to position the rail 11 horizontally.

To this end, for each of the fastening components 41, the upper face 41B (of the central plate 42) and the lower faces 41A (of the lateral plates 43 and 44), illustrated in FIG. 4 respectively by dashed line segments D1 and D2, form between them a non-zero angle α. This angle α is such that, when the system 1 is installed on the instrument panel 2, the rail 11 is in a horizontal position.

Consequently, the fastening components 41 are configured so as:
to be able to be fastened to the supports 8A and 8B of the footrests 9A and 9B; and
to be able to be fastened below the rail 11, in order to position it horizontally.

Furthermore, the system 1 also comprises a bearing component 49 shown in FIGS. 1 and 2. This bearing component 49 is arranged between the lower face of the rail 11 and the upper face of a customary bracket 50 of the instrument panel 2, which is in a folded position, in order to provide additional holding of the rail 11.

Furthermore, the plate 30 is connected by way of a customary hinge 51 to the panel 15, as shown in FIG. 5.

As indicated above, the movable carriage 13 is configured to be able to be brought, by translational movement on the rail 11, into an end position P2 on said rail 11, such as the position shown in FIG. 5.

In the end position P2, the plate 30 of the support device 14 is able to pivot with respect to the panel 15 of the movable carriage 13, about an axis C-C (which is transverse, and preferably orthogonal, to said longitudinal axis A-A), as illustrated by a double-headed arrow EC in FIG. 5.

In this end position P2, the support device 14 is thus configured to be able to be brought, by the pivoting of the plate 30 about the axis C-C, into one or the other of the two following configurations:
the lowered configuration C1, in which the plate 30 is in contact with the panel 15 and the support device 14 is therefore lowered on the movable carriage 13; and
a rest configuration C3, in which the plate 30 and therefore the support device 14 are raised, as shown in FIG. 5.

In this rest configuration C3, the support device 14 and the screen 4 are positioned so as to hinder the pilot as little as possible, if at all.

The support device 14 is held in the lowered configuration C1, with the aid of self-gripping attachment means 52 (FIG. 5). The “scratch” self-gripping attachment means 52 are provided between the plate 30 and the panel 15 and have the function of attaching the plate 30 to the panel 15.

Furthermore, in the rest configuration C3, the support device 14 is held in position with the aid of a pivoting arm 53 (FIGS. 5 and 8) and self-gripping attachment means 54 (FIG. 6).

The “scratch” self-gripping attachment means 54 are provided between the auxiliary bracket 18 and a lateral edge of the rail 11.

The pivoting arm 53, preferably produced in the form of a rectangular planar plate, is able to pivot about an axis D-D (which is transverse, and preferably orthogonal, to said longitudinal axis A-A), as illustrated by a double-headed arrow ED in FIG. 8.

The pivoting arm 53, which is connected at one end 53A by way of a customary hinge to the panel 15, can be brought into one or the other of the two following positions:
a retracted position, in which it is retracted in a receptacle 55 (FIGS. 5 and 8) corresponding to a cutout provided in the panel 15; and
an inclined (support) position as shown in FIGS. 5 and 8, in which a free end 53B of the pivoting arm 53 enters an opening 57 (FIG. 7) in the plate 30 of the support device 14 in order to hold the support device 14 in said rest configuration C3.

Methods for installing and deinstalling the system 1 will now be described.

The method for installing the system 1 on the instrument panel 2 of an aircraft, so as to be usable by a pilot, notably comprises the following (manual) operations:
disposing the rail 11 in the appropriate position on the instrument panel 2;
installing the bearing component 49 between the rail 11 and the bracket 50;
fastening the two fastening components 41 of the fastening system 12 to the supports 8A and 8B of the two footrests 9A and 9B intended for the pilot, by screwing the bolts 47 in the pre-existing holes in the supports 8A and 8B. Preferably, for this last operation, the fastening components 41 (which are screwed to the rail 11 beforehand) are simply screwed to the supports 8A and 8B. In a variant, it is also conceivable for the fastening components 41 (which are screwed to the supports 8A and 8B beforehand) to be screwed to the rail 11 during this last operation.

Furthermore, the method for deinstalling the system 1 (previously installed on the instrument panel 2) notably comprises the following (manual) operations:
unscrewing the bolts 47 in order to separate the two fastening components 41 of the system 1 from the supports 8A and 8B of the footrests 9A and 9B to which they were fastened;
removing the rail 11 (and all the components that it bears);
removing the bearing component 49.

Consequently, the installation and the deinstallation of the system 1 can be carried out easily and rapidly, with a reduced number of operations, and additionally without needing to modify the instrument panel 2 or equipment in the cockpit 3 of the aircraft.

Furthermore, in order to move the movable carriage 13 (provided with the support device 14 and the screen 4) from a first position to a second position, for example from the operation position P1 to the end position P2 or vice versa, it suffices to carry out the following (manual) operations:
in the first position, loosening the locking element 38 in order to release the panel 15 from the rail 11;
moving the movable carriage 13 by causing it to slide on the rail 11 in order to bring it into the second position; and
in this second position, screwing the locking element 38 in order to prevent any movement of the movable carriage 13.

By virtue of the rail 11 which is arranged on the instrument panel 2, the movable carriage 13 can be brought to any desired position along said rail 11, and in particular to the end position P2 and to the operation position P1 (in which the screen 4 is positioned in front of the customary screen 6 of the cockpit 3 in the example of FIGS. 1 and 2).

The system 1 thus provides a great degree of lateral positioning flexibility for the screen 4 in the cockpit 3.

Methods for bringing the support device 14 of the system 1 into different possible configurations will now be described.

The method for, notably in the operation position Pl on the rail 11, causing the support device 14 to pass from the raised configuration C2 in FIG. 1 to the lowered configuration C1 in FIG. 2 notably comprises the following (manual) operations:
acting on the screw adjuster 64 in order to allow the support bracket 16 to pivot via the hinge 19;
moving the support bracket 16 bearing the screen 4 by causing it to pivot about the axis B-B in order to bring it from the vertical position (relative to the raised configuration C2) to a horizontal position (in which it is in contact with the auxiliary bracket 18), the auxiliary bracket 18 resting on the plate 30 which itself rests on the panel 15 connected to the rail 11; and
introducing the clamp 24 into the opening 26 in order to secure the support bracket 16 to the auxiliary bracket 18.

Furthermore, the method for, notably in the operation position Pl on the rail 11, causing the support device 14 to pass from the lowered configuration C1 in FIG. 2 to the raised configuration C2 in FIG. 1 notably comprises the following (manual) operations:
removing the clamp 24 from the opening 26 in order to disconnect the support bracket 16 from the auxiliary bracket 18;
moving the support bracket 16 bearing the screen 4 by causing it to pivot about the axis B-B in order to bring it from the horizontal position (in which it is in contact with the auxiliary bracket 18) to the vertical position (relative to the raised configuration C2); and
acting on the screw adjuster 64 in order to prevent pivoting of the support bracket 16.

Consequently, the change of configuration of the support device 14, notably in the operation position P1, can be carried out easily and rapidly, with a reduced number of operations.

Furthermore, the method for, in the end position P2 on the rail 11, causing the support device 14 to pass from a lowered configuration C1 such as the one in FIG. 2 to the rest configuration C3 in FIG. 5 notably comprises the following (manual) operations:
moving the support device 14 bearing the screen 4 by causing it to pivot about the axis C-C in order to bring it from the horizontal position (in which it rests on the rail 11) to the vertical position (relative to the rest configuration C3); and
causing the pivoting arm 53 to pivot about the axis D-D in order to bring it from the retracted position to the inclined position in which its free end 53B enters the opening 57 in the plate 30. In this inclined position, the pivoting arm 53 holds the support device 14 in the (vertical) rest configuration.

Furthermore, the method for, in the end position P2 on the rail 11, causing the support device 14 to pass from the rest configuration C3 in FIG. 5 to a lowered configuration C1 such as the one in FIG. 2 notably comprises the following (manual) operations:
causing the pivoting arm 53 to pivot from the inclined position to the retracted position so as to permit the pivoting of the support device 14; and
moving the support device 14 bearing the screen 4 by causing it to pivot about the axis C-C in order to bring it into the horizontal position (relative to the lowered configuration C1).

Consequently, the change of configuration of the support device 14, in the rest position P2, can be carried out easily and rapidly, with a reduced number of operations.

The system 1 as described above has a very large number of advantages. In particular:
it can be installed on the instrument panel, without modification of the instrument panel and equipment in the cockpit of the aircraft;
the installation and the deinstallation of the system 1 can be carried out easily and rapidly;
the operations for installation and deinstallation are operations that are simple and few;
the system 1 has a reduced cost;
the support device and the screen can be brought into the desired position along the rail, and in particular into a position adapted to the field of vision of the pilot;
when the pilot no longer needs the screen, the support shell and the screen that it bears can either be brought into the rest configuration or be removed rapidly in the event of an emergency, such that they do not hinder the pilot;
the system 1 can be used for a screen intended for the pilot or for a screen intended for the co-pilot; and
the system 1 can be used for any type of additional screen, and in particular for a test screen.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A system for removably fastening at least one screen to an instrument panel of a cockpit of an aircraft, the system comprising:
a rectilinear rail having a longitudinal axis;
a fastening device configured to fasten the rectilinear rail to an instrument panel without modification of said instrument panel; and
at least one movable carriage provided with a support device, said at least one movable carriage configured to move in translation along said rectilinear rail and to be brought into an operation position,
said support device being provided with a support bracket configured to bear a screen, the support bracket configured to pivot about an axis parallel to said longitudinal axis and being configured to, by the pivoting thereof, be raised into a raised configuration in said operation position, and to be able to be lowered on the movable carriage into a lowered configuration, at least during a translational movement of said movable carriage on the rail.

2. The system according to claim 1, wherein the movable carriage is configured to be brought, by translational movement on the rectilinear rail, into an end position on said rectilinear rail, and
wherein the support device is configured to pivot with respect to a panel of the at least one movable carriage, about an axis which is transverse to said longitudinal axis, and, by the pivoting thereof, is configured to, in said end position, be raised into a rest configuration.

3. The system according to claim 1, wherein the support device further comprises an auxiliary bracket, and
wherein the support bracket is configured to pivot with respect to said auxiliary bracket by a hinge arranged at a first side, and further configured to, by pivoting, be brought into one or the other of the two following configurations:
the lowered configuration, in which the support bracket is folded down on the auxiliary bracket so as to create a receptacle configured to receive the screen and the support bracket and the auxiliary bracket are secured to one another at a second side on the opposite side from said first side; and
a raised configuration, in which the support bracket is raised with respect to the auxiliary bracket such that the support bracket and the auxiliary bracket are positioned substantially orthogonally with respect to one another.

4. The system according to claim 3, wherein a first face of the auxiliary bracket and a first face of a plate connected to a panel of the movable carriage are in contact with one another and are connected to one another by a plurality of pins which are secured to at least one of said first faces and enter complementary and cooperating holes provided in the other of said first faces, and, for the other of said first faces, at least one double-sided adhesive strip, each face of which is adhesively bonded to one of said first faces of the auxiliary bracket and of the plate.

5. The system according to claim 1, further comprising:
a locking element configured to lock the at least one movable carriage in position on the rectilinear rail.

6. The system according to claim 1, wherein the fastening device comprises two fastening components arranged below the rectilinear rail,
wherein each of said fastening components comprises a lower face configured to be fastened a footrests of the aircraft and an upper face to which the rectilinear rail is fastened, and
wherein the two fastening components are configured such that, when the fastening system is mounted on the instrument panel, the rectilinear rail is positioned substantially horizontally.

7. The system according to claim 1, further comprising:
at least one bearing component arranged below the rectilinear rail.

8. The system according to claim 1, further comprising:
at least one pivoting arm configured to pivot about an axis transverse to said longitudinal axis so to be brought into one or the other of the two following positions:
a retracted position, in which the at least one pivoting arm is retracted in a panel of the movable carriage; and
an inclined position, in which a free end of the at least one pivoting arm enters an opening in a plate of the support device in order to hold the support device in a rest configuration.

9. The system according to claim 1, further comprising:
self-gripping attachment means for attaching together different elements of the system.

10. A removable visualization system for an instrument panel of a cockpit of an aircraft, said visualization system comprising:
at least one screen, and,
the system according to claim 1,
wherein the at least one screen is fastened to an instrument panel of a cockpit of an aircraft.
